(19) United States
(12) Patent Application Publication
(10) Pub. No.: US 2015/0288022 A1
(43) Pub. Date: Oct. 8, 2015

(54) SECONDARY BATTERY

(71) Applicant: SK INNOVATION CO., LTD, Seoul (KR)

(72) Inventor: Jae Myoung Lee, Daejeon (KR)

(73) Assignee: SK Innovation Co., Ltd., Seoul (KR)

(21) Appl. No.: 14/443,025

(22) PCT Filed: Nov. 15, 2013
(86) PCT No.: PCT/KR2013/010406

§ 371 Date: May 14, 2015

(30) Foreign Application Priority Data
Nov. 16, 2012 (KR) 10-2012-0130311

(51) Int. Cl. H01M 10/04; H01M 10/052

(52) U.S. Cl. CPC H01M 10/0431; H01M 10/052; H01M 2220/30; H01M 2220/20

(57) ABSTRACT

The present invention relates to a secondary battery comprising: a battery assembly formed from a positive electrode plate, a separator and a negative electrode plate which are sequentially stacked or wound; a finishing unit for covering the outer surface of the battery assembly in a first direction; and an end tape, the ends of which are fixed to one side and another side of the finishing unit such that the one side of the finishing unit can be elastically drawn in the first direction toward the other side of the finishing unit.

### CROSS-REFERENCE TO RELATED APPLICATION

This application claims the benefit of Korean Patent Application No. 10-2012-0130311, filed Nov. 16, 2012, which is hereby incorporated by reference in its entirety into this application.

### TECHNICAL FIELD

The present invention relates to a secondary battery.

### BACKGROUND ART

Generally, due to the demand for decreasing the Weight and increasing the functionality of portable electronic devices such as video cameras, mobile phones, and portable computers, thorough research is ongoing into secondary batteries serving as a power source for driving such devices.

Such secondary batteries include, for example, nickel-cadmium batteries, nickel-hydrogen batteries, nickel-zinc batteries, lithium secondary batteries, etc.

In particular, lithium secondary batteries may be manufactured to be small or large and possess high operating voltage and high energy density per unit weight, and may thus be widely utilized in a variety of application fields.

Recently, with the goal of solving an pollution problems caused by existing gasoline or diesel vehicles using tonsil fuel, electric vehicles (EVs), hybrid electric vehicles (HEVs), and plug-in hybrid electric, vehicles (P-HEV), which employ chargeable secondary batteries, are being actively developed.

Unlike small mobile devices, medium- or large-sized devices such as cars are required to use high-power secondary batteries having large capacity, and thus a medium- or large-sized battery pack comprising a plurality of cell batteries connected to each other is adopted.

Since medium- or large-sized battery packs are manufactured to be as small and light as possible, angular batteries, pouch-shaped batteries, etc., which may be stacked with a high degree of integration and have low weight per capacity, are mainly utilized as cell batteries of medium- or large-sized battery packs.

In particular, pouch-shaped batteries are receiving great attention because of low weight, low leakage probability of electrolyte, and low manufacturing cost.

Such a secondary battery is disclosed in Korean Patent No. 10-0280720.

As disclosed in the above patent, the existing secondary battery includes a battery assembly configured such that a cathode plate, a separator and an anode plate are wound. Alternatively, a battery assembly may be formal by stacking a cathode plate a separator, and an anode plate.

Such a battery assembly is maintained in the form of being wound or stacked using an additional finishing unit for covering the outer surface of the battery assembly. Covering the outer surface of the battery assembly by the finishing unit is carried out wider the condition that the wound or stacked battery assembly is gripped by a gripper.

Then, the gripper is removed from the battery assembly alter covering of the outer surface of the battery assembly including the gripper by the finishing unit. As such, a space as large as the volume of the removed gripper is formed inside the finishing unit. Such a space causes the outer surface of the battery assembly to be somewhat loosely covered by the finishing unit. As the battery assembly is loosely covered by the finishing unit, the edge of the finishing unit protrudes and the protruding edge of the finishing unit may have a negative influence on processes of accommodating the battery assembly in a pouch and sealing the pouch. Thereby, conventional secondary batteries may become structurally poor.

### DISCLOSURE

### Technical Problem

Accordingly, the present invention has been made keeping in mind the above problems encountered in the related art, and an aspect of the present invention is to provide a secondary battery, which is configured such that a finishing unit may cover the outer surface of a battery assembly without any space even upon removal of a gripper.

### Technical Solution

An embodiment of the present invention provides a secondary battery, comprising: a battery assembly comprising a cathode plate, a separator and an anode plate, which are sequentially stacked or wound; a finishing unit for covering an outer surface of the battery assembly in a first direction; and an end tape, opposite ends of which are fixed to a first side and a second side of the finishing unit so that the first side of the finishing unit is elastically drawn in the first direction toward the second side of the finishing unit.

In the secondary battery according to the embodiment of the present invention, the end tape may comprise any one rubber material selected from among styrene-butadiene rubber (SBR), butadiene rubber (BR), chloroprene rubber (CR), acrylonitrile butadiene rubber (NBR), butyl rubber (IIR), ethylene propylene rubber (EPM, EPDM), chlorosulfonated polyethylene rubber (CSM) acrylic rubber (ACM, ANM), fluoro rubber (FPM), silicone rubber (MQ, MVQ, MPVQ, MFQ), acrylonitrile ethylene rubber (NEM), epichlorohydrin rubber (CO, ECO), and urethane rubber (AU, EU).

In the secondary battery according to the embodiment of the present invention, the end tape may have an elongation of 50˜900%.

In the secondary battery according to the embodiment of the present invention, the end tape may have an elastic modulus of 0.001˜0.1 Gpa.

In the secondary battery according to the embodiment of the present invention, the end tape may include an adhesive layer formed on the opposite ends thereof so as to be fixedly attached to the finishing unit.

In the secondary battery according to the embodiment of the present invention, a width of a portion between the opposite ends of the end tape in a second direction perpendicular to the first direction may be smaller than a width of the opposite ends of the end tape in the second direction.

In the secondary battery according to the embodiment of the present invention, the end tape may have at least one hole in a portion between the opposite ends thereof.

In the secondary battery according to the embodiment of the present invention, the hole may have a circular shape, a quadrangular shape, or an elliptical shape.

In the secondary battery according to the embodiment of the present invention, the at least one hole may comprise a plurality of holes.

In the secondary battery according to the embodiment of the present invention, the hole may be a long hole formed across a center of the portion between the opposite ends of the end tape in the first direction.

In the secondary battery according to the embodiment of the present invention, the finishing unit may comprise an extension of the separator.

### Advantageous Effects

According to the present invention, a secondary battery is configured such that a finishing unit can elastically cover the outer surface of a battery assembly by means of an end tape. In particular, when a gripper is removed, the end tape enables the first side of the finishing unit to be drawn toward the second side thereof, whereby the finishing unit can come into close contact with the battery assembly without any space between the finishing unit and the battery assembly to thereby cover the outer surface of the batters assembly. Therefore, the finishing unit does not cause problems with protruding of edges, and thereby processes of accommodating the battery assembly in a pouch and sealing the pouch can be efficiently carried out.

### DESCRIPTION OF DRAWINGS

FIG. 1 is a perspective view illustrating a secondary battery according to an embodiment of the present invention;

FIG. 2 is a cross-sectional view of the secondary battery of FIG. 1;

FIG. 3 is an enlarged cross-sectional view of the area A of FIG. 2; and

FIGS. 4 to 6 are top plan views illustrating examples of the end tape of FIG. 1.

### BEST MODE

The above and other objects, features and advantages of the present invention will be more clearly understood from the following detailed description taken in conjunction with the accompanying drawings.

Throughout the drawings, it is noted that the same constituents are represented by the same reference numerals as possible even when depicted in different drawings.

Also, the terms “first side”, “second side”, “first”, “second” and so on are used to distinguish one constituent from another constituent, and the constituents are not limited by such terms.

Also, a detailed description of the related known technology that may unnecessarily obscure the gist of the present invention will be omitted.

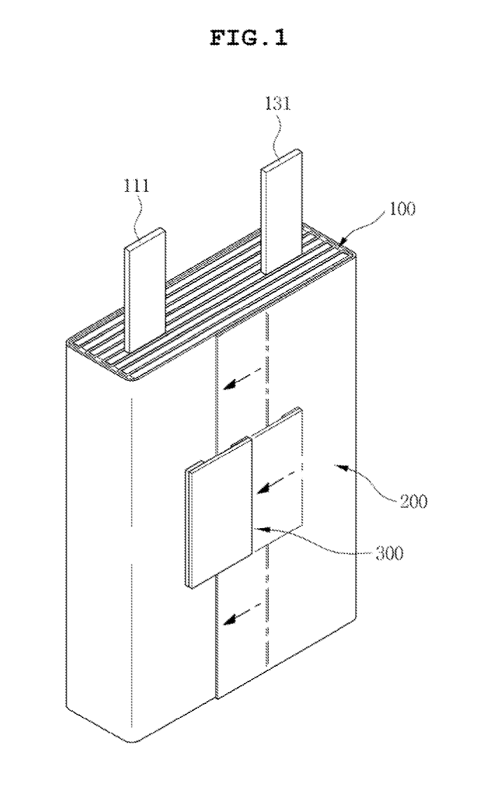

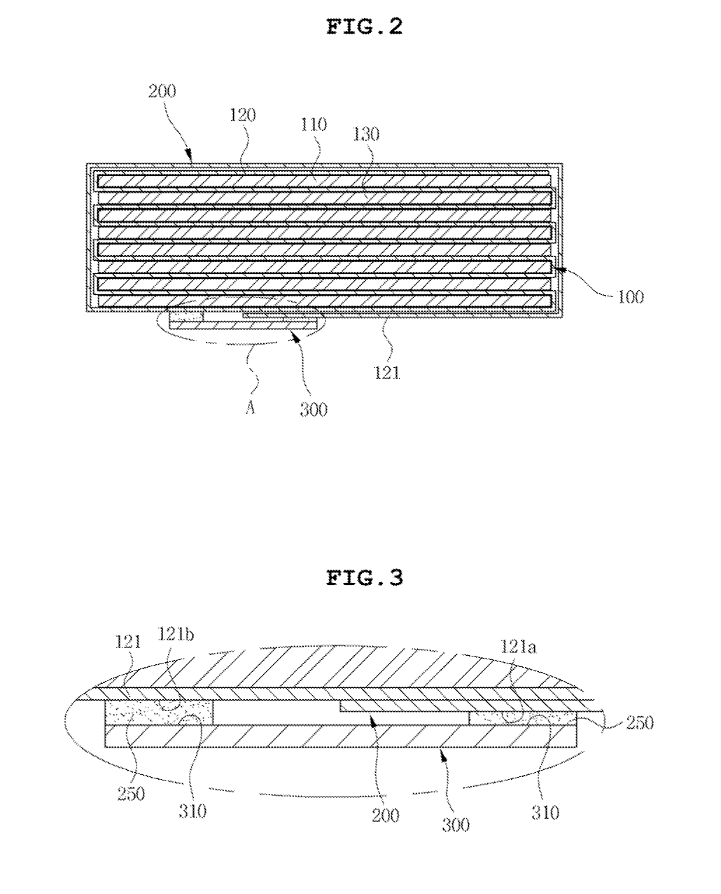

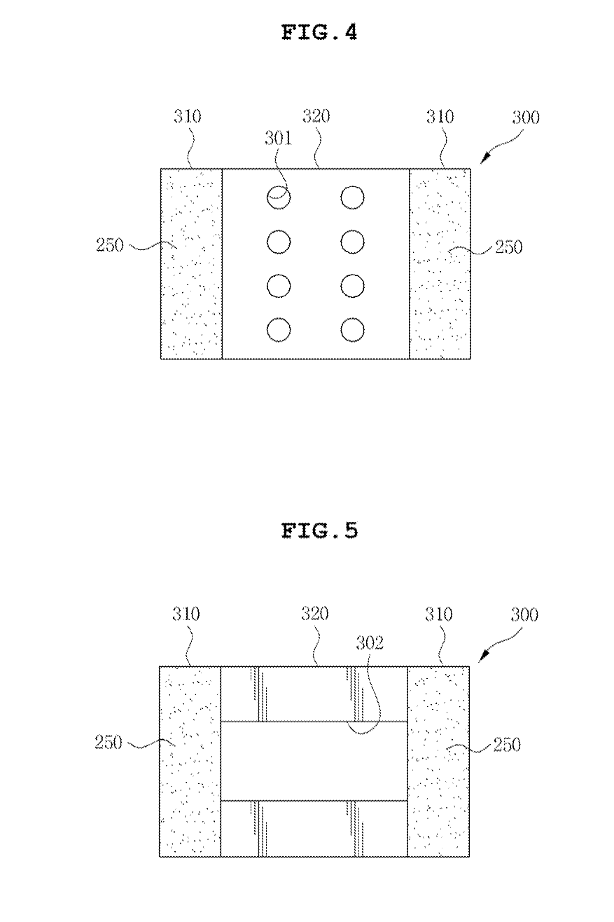

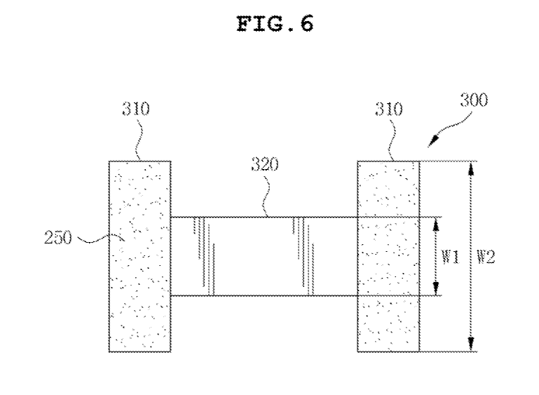

Hereinafter, a detailed description will be given of embodiments of the present invention with reference to the appended drawings. FIG. 1 is a perspective view illustrating a secondary battery according to an embodiment of the present invention, FIG. 2 is a cross-sectional view of the secondary battery of FIG. 1, FIG. 3 is an enlarged cross-sectional view of the area A of FIG. 2, and FIGS. 4 to 6 are top plan views illustrating examples of the end tape of FIG. 1.

As illustrated in FIGS. 1 to 3, a secondary battery according to an embodiment of the present invention includes: a battery assembly 100 comprising a cathode plate 110, a separator 120 and an anode plate 130, which are sequentially stacked or wound; a finishing unit 200 for covering the outer surface of the battery assembly 100 in a first direction; and an end tape 300, the opposite ends of which are fixed to a first side and a second side of the finishing unit 200 so that the first side of the finishing unit 200 is elastically drawn toward the second side of the finishing unit 200 in the first direction.

In the present embodiment, the battery assembly 100, which is incorporated in a typical secondary battery module may include the cathode plate 110 comprising a cathode current collector coated with a cathode active material layer, the anode plate 130 comprising an anode current collector coated with an anode active material layer, and a separator 120 interposed between the cathode plate 110 and the anode plate 130.

The battery assembly 100 may be formed by sequentially stacking or winding the cathode plate 110, the separator 120, and the anode plate 130.

FIG. 2 illustrates the battery assembly 100 formed in a stacking manner. The battery assembly 100 thus formed is configured such that cathode plates 110 and anode plates 130 are stacked and the separator 120 is formed in a zigzag type therebetween.

Such a battery assembly 100 may be accommodated in a pouch (not shown) made of a thin aluminum laminate film and then the pouch is sealed.

The cathode plate 110 and the anode plate 130 may be linked respectively to electrode taps 111, 131 (FIG. 1). The electrode taps connected to the cathode plate 110 and the anode plate 130 include an electrode tap 111 for a cathode and an electrode tap 131 for an anode.

The electrode tap 111 for a cathode and the electrode tap 131 for an anode may be provided in the form of a sheet. Such electrode taps 111, 131 protrude from outside the battery assembly 100. The electrode taps 111, 131 thus formed allow the flow of current to be guided to inside or outside the battery assembly 100. As such, the electrode tap 111 for a cathode may be made of, for example, an aluminum metal material, and the electrode tap 131 for an anode may be made of, for example, a copper metal material.

In the present embodiment, the finishing unit 200 is provided to cover the outer surface of the battery assembly 100 so that the battery assembly 100 is maintained in the form of being wound or stacked.

The finishing unit 200 covers the outer surface of the wound or stacked battery assembly 100 in the first direction. As such, the finishing unit 200 may be separately provided from the separator 120, but may be composed of an extension 121 integratedly extending from the end of the separator 120 after completion of the stacking process, as illustrated in FIG. 2. Specifically, the outer surface of the battery assembly 100 may be finally covered by the extension 121 of the separator 120 remaining after formation of the separator 120 in a zigzag type between the cathode plates 110 and the anode plates 130, which are stacked. The extension 121 of the separator 120 may be regarded as the finishing unit 200.

Although not shown, when the battery assembly 100 is formed in a winding manner, the finishing unit 200 may be separately provided from the separator 120 so as to cover the outer surface of the battery assembly 100. Alternatively, the finishing unit 200 may be composed of an extension 121 of the separator 120, and thus the outer surface of the battery assembly 100 may be finally covered by the extension 121.

Meanwhile, the process of covering the outer surface of the battery assembly 100 by the finishing unit 200 is described. Specifically, up/down or left/right of the stacked or wound battery assembly 100 may be gripped by a gripper (not shown). Then, the gripper enables the battery assembly 100 to be rotated, and in the course of rotating the battery assembly 100, the outer surface of the battery assembly 100 may be covered by the finishing unit 200.

Thereby, the finishing unit 200 covers the outer surface of the battery assembly 100 together with the gripper that grips the outside of the battery assembly 100. Specifically, the outer surface of the battery assembly 100 is covered by the finishing unit 200 and then the end of the finishing unit 200 is fixed using an additional fixer. Then, the role of the gripper is completed, and thus the gripper is removed from the battery assembly 100. As such, a space as large as the volume of the removed gripper is formed between the finishing unit 200 and the battery assembly 100. The finishing unit 200 has to be elastically tightened so as to prevent formation of such a space when the gripper is removed. To this end, the end tape 300 is used in the present embodiment.

The opposite ends of the end tape 300 are fixed to the first and the second side of the finishing unit 200. Specifically, a first end of the end tape 300 is fixed to the first side of the finishing unit 200, and a second end of the end tape 300 is fixed to the second side of the finishing unit 200.

The first and the second side of the finishing unit 200 are two positions of the finishing unit 200 on the line of the first direction in which the finishing unit 200 covers the outer surface of the battery assembly 100. For example, the first side of the finishing unit 200 may be any one position 121a (FIG. 3) of the terminal portion of the finishing unit 200. As such, the second side of the finishing unit 200 may be any one position 121b (FIG. 3) of the initial portion of the finishing unit 200 by which the outer surface of the battery assembly 100 begins to be covered.

When the opposite ends of the end tape 300 are fixed to the first and the second side of the finishing unit 200 in this way, the finishing unit 200 is prevented from being loosened by the end tape 300.

As mentioned above, in order for the finishing unit 200 to be tightened when the gripper is removed from the battery assembly 100, specifically, in order for the first side of the finishing unit 200 to be drawn toward the second side of the finishing unit 200 in the first direction, the end tape 300, the opposite ends of which are fixed to the first and the second side of the finishing unit 200, may be made of an elastic material.

Specifically, the end tape 300 may be made of any one rubber material selected from among styrene-butadiene rubber (SBR), butadiene rubber (BR), chloroprene rubber (CR), acrylonitrile butadiene rubber (NBR), butyl rubber (IIR), ethylene propylene rubber (EPM, EPDM), chlorosulfonated polyethylene rubber (CSM), acrylic rubber (ACM, ANM), fluoro rubber (FPM), silicone rubber (MQ, MVQ, MPVQ, MFQ), acrylonitrile ethylene rubber (NEM), epichlorohydrin rubber (CO, ECO), and urethane rubber (AU, EU).

As such, the end tape 300 may have an elongation of 50˜900% and an elastic modulus of 0.001˜0.1 Gpa.

Such an end tape 300 may be in an elongated state when fixed to the finishing unit 200 to draw the first side of the finishing unit 200 toward the second side thereof.

More specifically, the length of the end tape 300 is increased when the opposite ends thereof are fixed to the first and the second side of the finishing unit 200. As such, when a space is created due to removal of the gripper, the end tape 300 enables the first side of the finishing unit 200 to be drawn in the first direction toward the second side of the finishing unit 200, as illustrated in FIG. 1, in the course of being returned to an original shape thereof. As the first side of the finishing unit 200 is drawn toward the second side thereof by means of the end tape 300, the finishing unit 200 may cover the outer surface of the battery assembly 100 without any space between the finishing unit 200 and the battery assembly 100.

Meanwhile, the end tape 300 is not fully fixed to the finishing unit 200, but the opposite ends of the end tape 300 are fixed thereto. When only the opposite ends of the end tape 300 are fixed to the finishing unit 200 in this way, the portion between the opposite ends of the end tape 300 may be freely stretched without being bound to the finishing unit 200.

Fixing the end tape 300 to the finishing unit 200 may include various processes, such as use of an additional fixer, etc., and may be illustratively carried out using an adhering process. As illustrated in FIG. 3, an adhesive layer 250 may be formed on the opposite ends 310 of the end tape 300, and the opposite ends 310 of the end tape 300 may be fixed to the first and the second side of the finishing unit 200 by the adhesive layer 250.

As such, the portion 320 between the opposite ends of the end tape 300 where the adhesive layer 250 is not formed may be freely stretched without being bound to the finishing unit 200.

The end tape 300 may be in an elongated state when fixed to the finishing unit 200 as mentioned above. In order to facilitate such an elongating process and to prevent the finishing unit 200 from being excessively drawn by the end tape 300, the end tape 300 has to possess appropriate elasticity.

The elasticity of the end tape 300 depends on the type of material, the elongation or the elastic modulus of the end tape 300.

The end tape 300 may also have appropriate elasticity by a morphological feature thereof. More specifically, the end tape 300 may have a simple rectangular shape as illustrated in FIG. 1, but the end tape 300 may have a morphological feature with at least one hole so as to further enhance elasticity, thereby ensuring appropriate elasticity as stated above.

With regard to the end tape 300 having at least one hole, FIG. 4 illustrates an end tape 300 having circular holes 301. As seen in the drawing, the end tape 300 may have circular holes 301 in the portion 320 between the opposite ends 310 fixed to the finishing unit 200, especially the portion 320 that is freely stretchable without being bound to the finishing unit 200. The number of holes 301 may be one, or may be plural as shown in the drawing. Also, the holes 301 may be regularly arranged in row and column as shown in the drawing. Although not shown, such holes may be irregularly arranged. Furthermore, the holes may have various shapes, such as a rectangular shape, a square shape, a rhombic shape, an elliptical shape, etc., in addition to the circular holes 301.

Also, FIG. 5 illustrates an end tape 300 having a long hole 302. As illustrated in this drawing, the end tape 300 may have a long hole 302 that is formed across the portion 320 between the opposite ends 310 fixed to the finishing unit 200 in the first direction. In particular, the long hole 302 may be formed at the center of the portion 320 between the opposite ends 310 of the end tape 300.

When such a hole 301, 302 is formed in the end tape 300 in this way, elasticity of the end tape 300 may be further enhanced, compared to when there is no hole. Thus, the end tape 300 may be efficiently stretched in the course of fixing it to the finishing unit 200, and may also appropriately draw the finishing unit 200.

In addition, the end tape 300 may have another morphological feature for enhancing elasticity of the end tape 300 in such a manner that the portion between the opposite ends of the end tape 300 is narrowly formed. Specifically, as illustrated in FIG. 6, the end tape 300 is funned such that the width of the portion 320 between the opposite ends 310 fixed to the finishing unit 200, especially the width W1 of the portion 320 in the second direction perpendicular to the first direction may be smaller than the width W2 of the opposite ends 310 of the end tape 300 in the second direction. As such, the portion 320 between the opposite ends 310 of the end tape 300 is provided in the form of a strip shape that connects the opposite ends of the end tape 300. The end tape 300 has a total ‘H’ shape.

As the end tape 300 is provided in such a shape, its elasticity may be further enhanced, compared to the end tape 300 having a simple rectangular shape.

Although the embodiments of the present invention have been disclosed for illustrative purposes, those skilled in the art will appreciate that various modifications, additions and substitutions are possible, without departing from the scope and spirit of the invention as disclosed in the accompanying claims.

Accordingly, simple modifications or variations of the present invention fall within the scope of the present invention as defined in the accompanying claims.

<Description of the Reference Numerals in the Drawings>

| | |
|---|---|
| 100: battery assembly | 110: cathode plate |
| 111: electrode tap | 120: separator |
| 130: anode plate | 131: electrode tap |
| 200: finishing unit | 250: adhesive layer |
| 300: end tape | 301: circular hole |
| 302: long hole | |

1. A secondary battery, comprising:
a battery assembly comprising a cathode plate, a separator and an anode plate, which are sequentially stacked or wound;
a finishing unit for covering an outer surface of the battery assembly in a first direction; and
an end tape, opposite ends of which are fixed to a first side and a second side of the finishing unit so that the first side of the finishing unit is elastically drawn in the first direction toward the second side of the finishing unit.

2. The secondary battery of claim 1, wherein the end tape comprises any one rubber material selected from among styrene-butadiene rubber (SBR), butadiene rubber (BR), chloroprene rubber (CR), acrylonitrile butadiene rubber (NBR), butyl rubber (IIR), ethylene propylene rubber (EPM, EPDM), chlorosulfonated polyethylene rubber (CSM), acrylic rubber (ACM, ANM), fluoro rubber (EPM), silicone rubber (MQ, MVQ, MPVQ, MFQ), acrylonitrile ethylene rubber (NEM), epichlorohydrin rubber (CO, ECO), and urethane rubber (AU, EU).

3. The secondary battery of claim 1, wherein the end tape has an elongation of 50˜900%.

4. The secondary battery of claim 1, wherein the end tape has an elastic modulus of 0.001˜0.1 Gpa.

5. The secondary battery of claim 1, wherein the end tape includes an adhesive layer formed on the opposite ends thereof so as to be fixedly attached to the finishing unit.

6. The secondary battery of claim 1, wherein a width of a portion between the opposite ends of the end tape in a second direction perpendicular to the first direction is smaller than a width of the opposite ends of the end tape in the second direction.

7. The secondary battery of claim 1, wherein the end tape has at least one hole in a portion between the opposite ends thereof.

8. The secondary batter of claim 7, wherein the hole has a circular shape, a quadrangular shape, or an elliptical shape.

9. The secondary battery of claim 7, wherein the at least one hole comprises a plurality of holes.

10. The secondary battery of claim 7, wherein the hole is a long hole formed across a center of the portion between the opposite ends of the end tape in the first direction.

11. The secondary battery of claim 1, wherein the finishing unit comprises an extension of the separator.
